(19) United States
(12) Patent Application Publication
(10) Pub. No.: US 2002/0133716 A1
(43) Pub. Date: Sep. 19, 2002

(54) Rule-based operation and service provider authentication for a keyed system

(76) Inventor: Shlomi Harif, Austin, TX (US)

Correspondence Address: Jeffrey S. LaBaw, International Business Machines Corp., 11400 Burnet Rd. - 4054, Austin, TX, 78758, US

(21) Appl. No.: 09/751,829

(22) Filed: Dec. 29, 2000

Related U.S. Application Data
(60) Provisional application No. 60/230,107, filed on Sep. 5, 2000.

(51) Int. Cl. H04L 9/32

(52) U.S. Cl. 713/201

(57) ABSTRACT

A keyed authentication system and method employing rule based operation and service provider authentication techniques are described herein to provide for governing access and/or operation privileges for use environments such as vehicles, buildings, homes, computers, equipment, and intelligence. Broadly speaking, the system employs the use of an access device, including an identification tag, which may be validated by an authentication device to grant specific access and/or operation privileges to the controlled use environment. The identification tag encoded on the access device may be aligned with a set of rules that establish the level of access and/or operation for each unique identification tag. An application service provider may maintain the plurality of identification tags and associated rule sets and authorize trusted encoding devices to program the desired identification tags and associated rule sets into the plurality of access and authentication devices within the system.

### PRIORITY CLAIM

This application claims priority to the provisional application serial No. 60/230,107 entitled “Rule-Based Vehicle Operation and Service Provider Authentication” by Shlomi Harif, filed Sep. 5, 2000.

### BACKGROUND OF THE INVENTION

1. Field of the Invention

This invention relates to keyed systems, and more particularly to rule-based operation and service provider authentication of a keyed system.

2. Description of the Related Art

The following descriptions and examples are not admitted to be prior art by virtue of their inclusion within this section.

Automakers are continually developing technologies to enhance the usability of vehicles. The concept of a master/valet key system has been widely adapted to many of the vehicles being sold to consumers today. A master/valet key system allows a vehicle to provide limited access capabilities to the owners. In particular, the master key would allow complete access to the vehicle and operation, while the valet key may allow a vehicle to be operable but restrict access to the glove compartment and trunk of the vehicle. Such a system may be valuable during situations in which the vehicle may be valet parked.

Vehicles have also been designed to provide users with varying environmental settings to meet their personal preferences. For example, seat adjustments to both the driver's and front passenger's seats may be stored into memory and recalled when a user desires the seat to be readjusted to the stored setting. Rear-view mirrors and side-view mirrors adjustments may also be stored into memory and recalled as desired. Climate controls such as, interior cabin temperature, for example may also be adjustable to a user's preference. Telescopic steering wheels have also been designed to store their positions in memory. These and other types of environmental controls have been designed such that a vehicle may be prepped with a user's set of preferences prior to the vehicle being operated. In some vehicles, all such preferences may be stored into a central control unit which may then be recalled by activation of a button located inside the vehicle cabin.

Despite these advances, a need exists for providing a plurality of vehicle access and/or operation privileges to the users. There are many situations where some provision for the different level of privileges would be useful. For example, the operational characteristics of a vehicle may be desired to be limited dependent on the user attempting to gain access and operation. Parents may wish to have the vehicle operate normally whenever they are operating it but limit the operational characteristics whenever their children are using the vehicle. They may also wish to have the ability to monitor the driving habits of the children and review them to provide guidance and/or disciplinary actions if desired. Retail car-dealerships would deter theft and the frequency of “drive-offs” if they could operationally limit the time period or distance a vehicle may be test-driven by a prospective buyer. Law enforcement agencies may wish to monitor and restrict vehicle operation characteristics for parolees.

It would therefore be desirable to provide for a keyed system that allows for flexibility in governing a plurality of vehicular access and/or operation privileges for a plurality of users. The desired system may also provide a plurality of usability levels as well. The system should also be extendable to other use environments such as homes, buildings, computers, and intelligence, for example, which may also benefit from providing a plurality of access, operation and/or usability privileges to the users.

### SUMMARY OF THE INVENTION

The problems outlined above are in large part addressed by rule-based operation and service provider authentication of a keyed system and methods thereof. The system and methods described herein provide for the governing of access and/or operation privileges for use in a variety of environments such as, vehicles, buildings, homes, computers, equipment, and intelligence, for example. Broadly speaking, a central authority arranged in a network may establish and administer a plurality of access and/or operation privileges. Data associated with the access and/or operation privileges (hereinafter “operation”) may be encoded into the plurality of access devices and authentication devices within the system. Encoding of the access and authentication devices may be performed by trusted encoding devices upon authorization from the central authority.

In an embodiment for a rule-based operation and service provider authentication of a keyed system, the network system, which may be the Internet, may include first and second computational devices. The first computational device may include a plurality of identification tags and associated rule sets. Each identification tag and rule set pair may establish a level of operation privileges to a user. The second computational device may be adapted to program an access device with at least one of the identification tags upon authorization from the first computational device and may further be adapted to program an authentication device with a plurality of the identification tags and associated rule sets upon authorization from the first computational device. The authentication device may be adapted to interface with the access device and provide the corresponding level of operation privileges to the user if the identification tag programmed on the access device matches with at least one of the identification tags programmed on the authentication device. The system may further include a third computational device adapted to program the access device with at least one of the identification tags upon authorization from the first computational device. The access device may be adapted to be periodically re-authenticated by the second and/or third computational device upon authorization from the first computational device.

A network system for providing a level of operation privileges to a user is also contemplated. The system may include an encoding device adapted to program an access device with at least one identification tag upon authorization by a central authority connected to the network system. In an embodiment, the network may include the Internet. The encoding device may further be adapted to program an authentication device with a plurality of identification tags and associated rule sets upon authorization by the central authority. The central authority may be adapted to maintain and administer the plurality of identification tags and associated rule sets. Each identification tag and rule set pair may establish a level of operation privileges to the user. The authentication device may be adapted to provide the corresponding level of operation privileges to the user, if upon establishing a communication link with the access device, the authentication device matches the identification tag stored on the access device with at least one of the plurality of identification tags stored on the authentication device.

A communication network providing a level of operation privileges to a user is contemplated. The system includes a central authority arranged in the network. The central authority may include a plurality of identification tags and associated rule sets. Each identification tag and rule set pair may establish a level of operation privileges for the user. The network may further include an access device adapted to store at least one of the plurality of identification tags and an authentication device adapted to store a plurality of the identification tags and associated rule sets. The network may further include an encoding device adapted to program the access device with at least one of the plurality of identification tags upon authorization from the central authority. The encoding device may further be adapted to program the authentication device with plurality of the identification tags and associated rule sets upon authorization from the central authority. The authentication device may be adapted to interface with the access device and provide the corresponding level of operation privileges to the user if the identification tag stored on the access device matches with at least one of the plurality of identification tags stored on the authentication device. The network, in an embodiment, may include the Internet.

Another embodiment of network system for providing a level of operation privileges to a user is contemplated. The network system may include the Internet. The system may include an access device adapted to store a programmed identification tag. The identification tag may be programmed upon authorization from a central authority connected to the network system. The system may also include an authentication device adapted to store a plurality of programmed identification tags and associated rule sets. The plurality of identification tag and associated rule sets may be programmed upon authorization by the central authority. Each identification tag and rule set pair may establish a level of operation privileges for the user. The central authority may maintain and administer the plurality of identification tags and associated rule sets. An encoding device may be adapted to program the access device and the authentication device upon authorization from the central authority. The authentication device may be further adapted to interface with the access device and provide the corresponding level of operation privileges to the user if the identification tag stored on the access device matches at least one of the plurality of identification tags stored on the authentication device.

A network system for providing a level of operation privileges to the user of a vehicle is contemplated. The network system may include the Internet and the system may include an access device adapted to store a programmed identification tag. The access device may be programmed upon authorization from a central authority connected to the network system. The system may also include a vehicle including an authentication device adapted to store a plurality of programmed identification tags and associated rule sets. The authentication device may be programmed upon authorization from the central authority. The central authority may maintain and administer the plurality of identification tags and associated rule sets. Each identification tag and rule set pair establishes a level of operation privileges to the user of the vehicle. The system may further include an encoding device adapted to program the access device and authentication device upon authorization from the central authority. The authentication device may further be adapted to interface with the access device and provide the corresponding level of operation privileges to the user if the identification tag programmed on the access device matches at least one of the plurality of identification tags programmed on the authentication device.

The authentication device may be coupled to an engine control module to establish the operation parameters for the vehicle corresponding to the level of operation privileges provided by the authentication device. The authentication device may further be coupled to an electronics system and a telematics system to establish the operational parameters for the vehicle corresponding to the level of operation privileges provided by the authentication device. The access device may further be adapted to be periodically re-authenticated by the encoding device upon authorization by the central authority and also be adapted to store data associated with operational metrics of the user during the use of the vehicle. The encoding device may be further adapted to re-authenticate the access device by retrieving the data and submitting the data to the central authority. The central authority may be adapted to authorize re-authentication of the access device if the data does not violate a level of eligibility for re-authentication as established by the rule set corresponding to the level of operation privileges provided to the user. The system may also include means for bypassing the current level of operation privileges as provided by the authentication device and providing a dissimilar level of operation privileges to the user. The means for bypassing the current level of operation privileges may be adapted to disable future access to the identification tag stored on the access device by the encoding device and the authentication device.

A method for providing a plurality of operation privileges to a user is contemplated. The method may include establishing a plurality of identification tags and associated rule sets. Each identification tag and rule set pair may correspond to a level of operation privileges that may be provided to the user. The method may also include programming an access device, using an encoding device operably linked via a network to a central authority which administers the plurality of identification tags and associated rule sets. The access device may be programmed with at least one of the plurality of identification tags. Programming may occur upon authorization from the central authority. The method may also include programming an authentication device, using the encoding device, with a plurality of the identification tags and associated rule sets. Programming of the authentication device may also occur upon authorization from the central authority. The method may further include establishing a communication link between the access device and the authentication device, retrieving the identification tag stored on the access device and comparing it with the plurality of identification tags stored on the authentication device. The method may include retrieving the rule set associated with the identification tag stored on the access device if the identification tag matches with at least one of the plurality of identification tags. The user may then be provided with the corresponding level of operation privileges to the user. The method may also provide a default level of operation privileges to the user is no match is made. The method may further include bypassing the corresponding level of operation privileges and providing an alternate level of operation privileges to the user dissimilar to the corresponding level of operation privileges. The alternate level of operation privileges may include complete operation privileges. Bypassing the corresponding level of operation privileges may include receiving a request from the user for bypassing the corresponding level of operation privileges and disabling future access to the identification tag programmed on the access device.

A method for authenticating an access device used for obtaining a level of operation privileges is also contemplated. The method may include establishing a communications link between an encoding device and a central authority connected via a network. The central authority may maintain and administer a plurality of identification tags and associated rule sets. Each identification tag and rule set pair may establish a level of operation privileges for a user. The method may also include receiving a request from the encoding device for authenticating an access device. The access device may be associated with a level of operation privileges provided to the user. The method may also include determining authorization of the authentication request. Determining authorization of the authentication request may include authenticating the encoding device to the central authority and retrieving data from the access device. The data may include operational metrics of the user for the corresponding level of operation privileges provided to the user by the access device. Determining authorization of the authentication request may then include authorizing the authentication request if the data conforms to the level of eligibility for authentication as established by the associated rule set corresponding to the level of privileges provided to the user. If the data violates the level of eligibility for authentication, the authentication request may be denied. Alternatively, if the access device is a slave to a master access device and the master access device is authenticated to the central authority, the authentication request may be authorized regardless of whether the data conforms to the level of eligibility.

A computer-readable medium is also contemplated. The computer-readable medium may include first program instructions executable on a first computational device for authenticating an encoding device by a central authority coupled to the encoding device by a network and second program instructions executable on the first computational device for authorizing a request sent via the network from the encoding device for programming an access device with an identification tag. The access device may be usable for accessing a controlled environment. The medium may further include third program instructions executable on the first computational device for authorizing a request from the encoding device for programming an authentication device with a plurality of identification tags and associated rule sets. Each identification tag and rule set pair may establish a level of operation privileges for a user. The medium may further include fourth program instructions executable on a second computational device for providing the corresponding level of operation privileges to the user if the identification tag programmed in the access device matches with at least one of the plurality of identification tags programmed in the authentication device. The fourth program instructions may further be executable for providing a default level of operation privileges to the user if a match does not exist. The medium may also include fifth program instructions executable on the second computational device for bypassing the corresponding level of operation privileges and providing a dissimilar level of operation privileges. The fifth program instructions may be further executable for disabling future access to the identification tag programmed in the access device.

Another computer-readable medium is contemplated. The computer-readable medium may include first program instructions executable on a computation device for authenticating an encoding device by a central authority coupled to the encoding device by a network and second program instructions executable on the computational device for authorizing a request from the encoding device for authenticating a first access device. The first access device may include a programmed identification tag associated with a level of operational privileges for a user. The second program instructions may further be executable to retrieve data from the access device. The data may include operational metrics of the user for the corresponding level of operation privileges provide to the user by the first access device. The second program instructions may also be executable for authorizing the authentication request if the data conforms to the level of eligibility for authentication as established for the corresponding level of operation privileges. The medium may include third program instructions executable on the computational device for authenticating a second access device to the central authority. The third program instructions may be further executable for authorizing the authentication request if the second access device is configured as a master to the first access device.

### BRIEF DESCRIPTION OF THE DRAWINGS

Other objects and advantages of the invention will become apparent upon reading the following detailed description and upon reference to the accompanying drawings in which:

FIG. 1 is a block diagram illustrating an embodiment of a keyed authentication system as described herein;

FIG. 2 is a block diagram illustrating an embodiment of an application service provider, a primary encoding device, and an auxiliary encoding device, that may be employed by embodiments of a keyed authentication system as described herein;

FIG. 3 is a block diagram illustrating an embodiment of an authentication device that may be employed by embodiments of a keyed authentication system as described herein;

FIG. 4 is a block diagram illustrating an embodiment of a programmable key that may be employed by embodiments of a keyed authentication system as described herein;

FIG. 5 illustrates an embodiment of the programmable key that may be employed by embodiments of a keyed authentication system as described herein;

FIG. 6 is a flow diagram illustrating an embodiment of a programming sequence that may be employed by embodiments of a keyed authentication system as described herein;

FIG. 7 is a flow diagram illustrating an embodiment of a validation sequence that may be employed by embodiments of a keyed authentication system as described herein; and

FIG. 8 is a flow diagram illustrating an embodiment of a re-authentication sequence that may be employed by embodiments of a keyed authentication system as described herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

A keyed authentication system and method employing rule based operation and service provider authentication techniques are described herein to provide for governing access and/or operation privileges for use in environments such as vehicles, buildings, homes, computers, equipment and intelligence. Broadly speaking, the system employs the use of an access device, including an identification tag, which may be validated by an authentication device to grant specific access and/or operation privileges to the controlled use environment. The identification tag encoded on the access device may be aligned with a set of rules that establish the level of access and/or operation for each unique identification tag. In other words, each identification tag may be associated with a use profile as defined by the associated rule set. An application service provider may maintain the plurality of identification tags and associated rule sets and authorize trusted encoding devices to program the desired identification tags and associated rule sets into the plurality of access devices and authentication devices within the system.

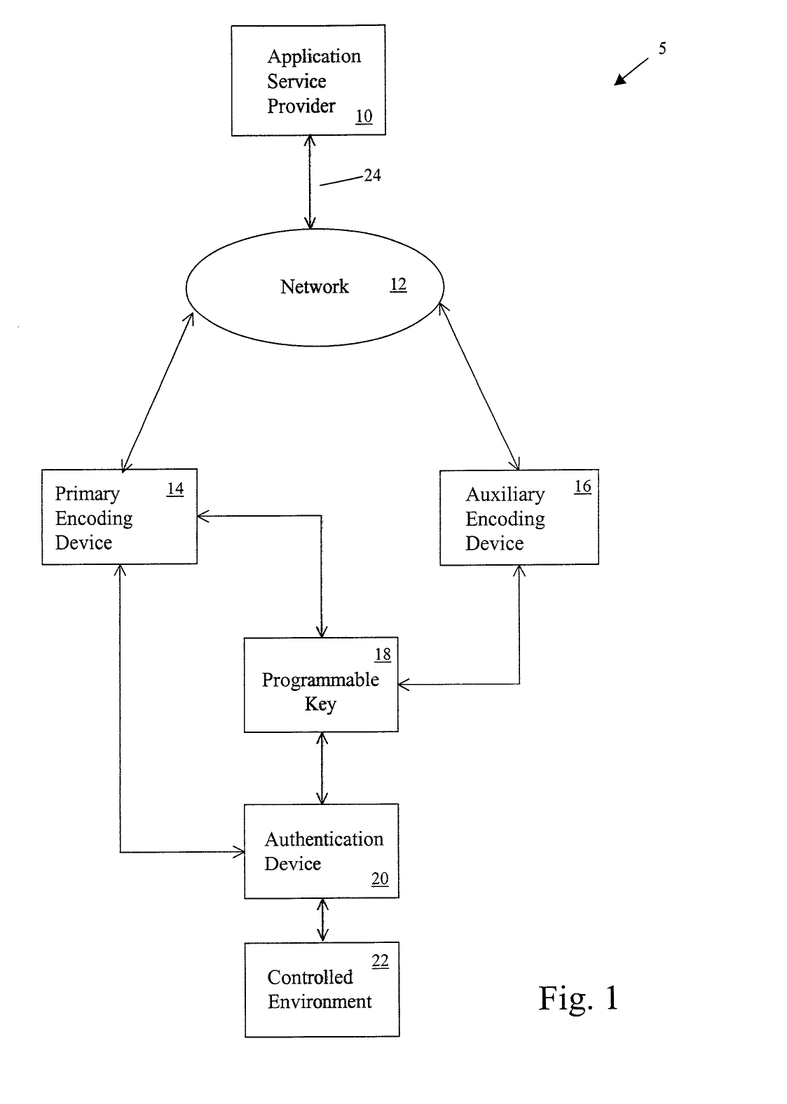

FIG. 1 is a block diagram schematically showing embodiments of a keyed authentication system 5 according to the present invention. As mentioned above, system 5 may be applied to any use environment (controlled environment 22) for providing different levels of access and/or operation privileges to a plurality of individuals. Examples of use environments which may employ a keyed authentication system such as system 5 are discussed later herein. System 5 may include application service provider 10, primary encoding device 14, auxiliary encoding device 16, programmable key 18 and authentication device 20 that communicate with each other directly or indirectly over network 12 by way of transmission medium 24. Transmission medium 24 may be, for example, a wire, cable, wireless transmission path, or a combination of these. For example, application service provider 10, primary encoding device 14, and auxiliary encoding device 16 may communicate through a wire-based transmission path while programmable key 18 may communicate with primary encoding device 14 and auxiliary encoding device 16 through a wireless transmission path. Network 12 may be a heterogeneous network, such as the Internet, or any other network system such as, Local-Area network (LAN), Wide-Area Network (WAN), System Area Network (SAN), Ethernet, or Token Ring, for example. Other network architectures may be employed. Protocols used for communicating along transmission medium 24 may include, but are not limited to, Transmission Control Protocol/Internet Protocol (TCP/IP), Hyper Text Transfer Protocol (HTTP), Wireless Applications Protocol (WAP), File Transfer Protocol (FTP), and Gopher. The protocol may be a secure communications link along transmission medium 24. Various encryption techniques may be employed in transferring of information between each component as well. In an embodiment, asymmetric encryption such as public key encryption may be employed. For example, a public key encryption scheme known as Public Key Infrastructure (PKI) may be employed. In particular, each component within a keyed authentication system may be assigned a unique identification, such as a digital certificate, from a certifying authority. The certifying authority may be an independent and trusted third party. The certifying authority may be application service provider 10. The digital certificate may be a packet of unique information stored in digital data form that may be used for identifying trusted components to each other within the encryption scheme. Thus, transferring of information among components of system 5 may occur only if their digital certificates can be authenticated. Each digital certificate may include a unique encryption key. Decrypting information may be done by using the public key. Each encryption/public key forms a mutually inclusive pair for securely transferring information. Other types of asymmetric encryption or symmetric encryption schemes may be used as well. Consequently, as used herein, the terms “communication” or “communicating” may be understood to include encryption/decryption aspects for transferring of information.

Although FIG. 1 illustrates application service provider 10, primary encoding device 14, auxiliary encoding device 16, programmable key 18, and authentication device 20 as single components, a plurality of each or any of these components may be employed. Naturally, the number of each element may be dependent on the use environment for which the keyed authentication system is employed. For example, an embodiment of a keyed authentication system may include an application service provider and a plurality of primary/auxiliary encoding devices, programmable keys, and authentication devices.

Functionality of the components constituting the embodiment of FIG. 1 will now be described. Application service provider (ASP) 10 may be the governing authority which administers the plurality of identification tags and rule sets for one or more use environments. Application service provider 10 may be a single centralized authority that oversees and manages a plurality of use environments. Alternatively, separate ASP entities may be utilized for each use environment. Application service provider 10 may include a network of computational devices able to communicate with each other and other devices connected directly or indirectly to network 12. Application service provider 10 maintains data associated with the plurality of identification tags and associated rule sets corresponding to different levels of access and/or operation (hereinafter “operation”) privileges. As used herein, the phrase “operation privileges” or its variants are understood to include any type of access and operation privilege in a given use environment. Each identification tag and rule set pair may be viewed as a use profile that may define a level of operation privileges permitted to a user in possession of the corresponding key. Accordingly, contents of the rule sets are entirely dependent on the use environment. Application service provider 10 may authorize the programming of the identification tags and rule sets only through trusted encoding sources as explained further herein.

Primary encoding device 14 may able to program a plurality of programmable keys 18 and authentication devices 20. As used herein, “programming” or “reprogramming” may refer to the act of writing, erasing, and/or reading information. Primary encoding device 14 may program programmable key 18 with one or more identification tags. Primary encoding device 14 may also have the ability to permanently disable functionality of programmable key 18, to retrieve data from programmable key 18, and to re-authenticate programmable key 18 as described below. Primary encoding device 14 may also program authentication device 20 with a plurality of identification tags and associated rule sets. Primary encoding device 14 may also augment a given rule set, as established and administered by ASP 10, with an additional rule set tailored to specific needs of the use environment. The additional rule set may also be programmed into authentication device 20 and further be transferred to ASP 10. Primary encoding device 14 is a trusted encoding source to ASP 10 such that programming by primary encoding device 14 may include requesting authorization from ASP 10. If primary encoding device 14 is authenticated by ASP 10, programming may occur as requested. If primary encoding device 14 cannot be authenticated, the programming request may be denied. Such authentication processes may prevent unauthorized programming of keys and authentication devices, thereby limiting abuse of the system.

Auxiliary encoding device 16 may also have the capability to program a plurality of programmable keys 18. Similarly, auxiliary encoding device 16 is a trusted encoding source to ASP 10. However, auxiliary encoding device 16 may only program a key with the identification tag as initially programmed on the key. It may not be capable of programming a different identification tag into programmable key 18. Such a device may be used in embodiment of the systems described herein employing periodic re-authentication of the programmable keys. Periodic re-authentication may prevent a stolen or misplaced programmable key 18 from being used, for example. In particular, auxiliary encoding device 16 may request re-authentication of programmable key 18 from ASP 10. Upon validation of the key, ASP 10 may then authorize auxiliary encoding device 16 to proceed with the re-authentication process. Auxiliary encoding device 16 may also retrieve data from programmable key 18.

Programmable key 18 may be an access device capable of storing one or more identification tags as programmed by primary encoding device 14 or auxiliary encoding device 16. In some embodiments, programmable key 18 may take on the shape and functionality of a conventional key with additional features as discussed herein. Programmable key 18 may be used to gain operation privileges as defined by the rule set associated with the identification tag stored on programmable key 18. The key is further capable of being reprogrammed by primary encoding device 14. Programmable key 18 may also store data such as use history of the key, for example. Other types of data may be stored as well, depending on the use environment. Data may be written to or retrieved from programmable key 18 by primary encoding device 14, auxiliary encoding device 16, and. authentication device 20. As mentioned above, programmable key 18 may require periodic re-authentication to minimize unauthorized use of the key in the event the key is stolen or misplaced, for example. Programmable key 18 may also be capable of being permanently disabled by primary encoding device 14 and authentication device 20. Programmable key 18 may also be programmed in a master/slave configuration. In other words, a plurality of slave keys may be associated with a master key. Depending on the use environment, a master key may be needed for re-authenticating and/or programming of the slave keys.

Authentication device 20 interfaces with controlled environment 22 to govern the level of operation privileges that may be granted to a user. Authentication device 20 may be programmed by primary encoding device 14 to store data including a plurality of identification tags and associated rule sets. Consequently, the stored data represents the set of programmable keys 18 that may be identifiable or validated by authentication device 20. Upon communication with programmable key 18, authentication device 20 reads the identification tag stored on the key and compares that tag with the plurality of stored identification tags. If a match exists, authentication device 20 grants the user with operation privileges as defined by the rule set associated with the matched identification tag. If a match does not exist, operation privileges are denied by authentication device 20, or a default level of operation may be allowed. The default level may be limited set of operation privileges. Authentication device 20 may also record data such as the use history of programmable key 18. Other types of operational data specific to the use environment may be stored as well. The data may be written to programmable key 18 for future retrieval by primary encoding device 14 and auxiliary encoding device 16. Authentication device 20 may also have the ability to permanently disable functionality of programmable key 18. An override feature may also be included. The override feature may allow the current level of operation privileges to be bypassed and may allow the user full operation privileges.

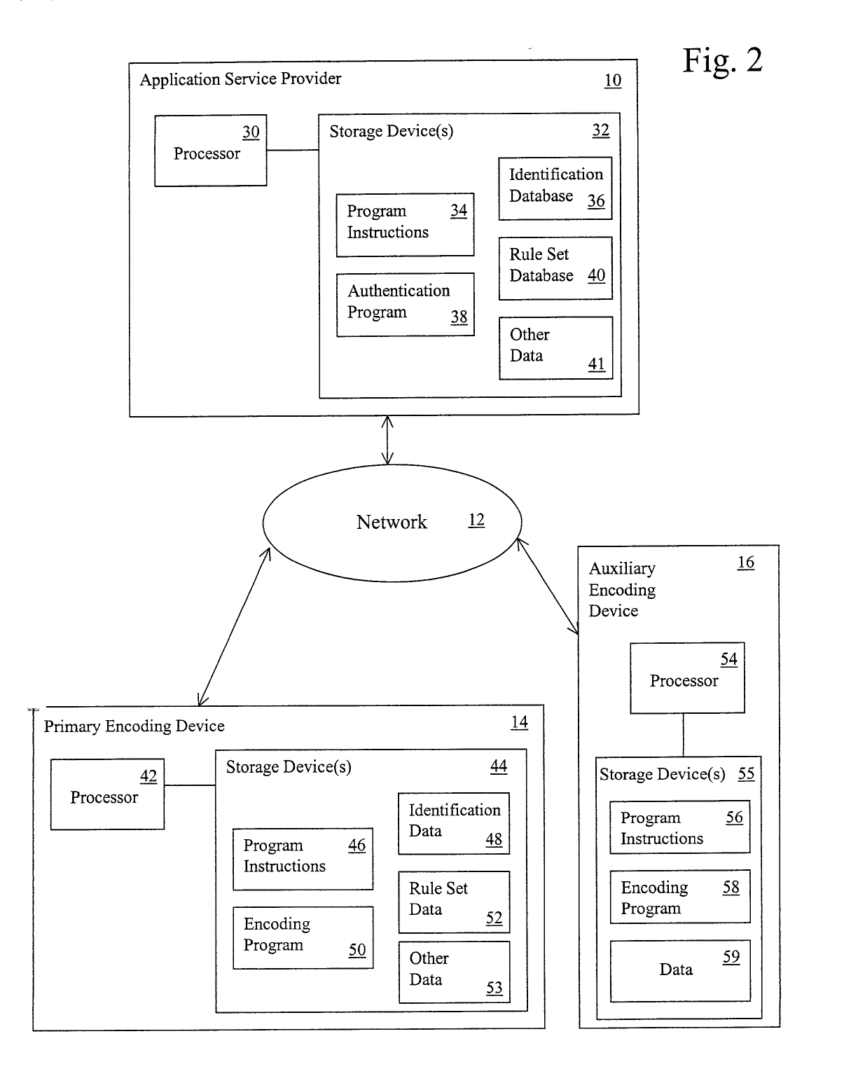

Turning now to FIG. 2, a block diagram is presented illustrating embodiments of components that may be included in application service provider 10, primary encoding device 14, and auxiliary encoding device 16 for systems and methods as described herein. Application service provider 10 may comprise a computational device including processor 30 and one or more storage devices 32. Although shown as a single computational device, ASP 10 may also comprise a network of computational devices. Storage device 32 (or storage medium), may take on many forms, such as volatile or non-volatile memory, a magnetic disk such as a hard drive or a floppy drive, an optical disk or a magnetic tape. Storage device 32 may include program instructions 34. The program instructions may be stored as “executable files” in storage device 32 and loaded into system memory during execution. Program instructions 34 may include various program instructions used to implement networking functions of application service provider 10, such as establishing communication over network 12 with primary encoding device 14 and auxiliary encoding device 16, for example. Instructions 34 may also include instructions for interfacing with other networked entities as described herein. Storage device 32 may also include authentication program 38. Although authentication program 38 may be implemented using program instructions such as instructions 34, authentication program 38 is shown separately in FIG. 2 to highlight this feature of application service provider 10. Authentication program 38 may include instructions for administering the plurality of identification tags and associated rule sets for a given use environment. The instructions may include, for example, authenticating requests from primary encoding device 14 or auxiliary encoding device 16 for programming programmable key 18 and/or authentication device 20 as described above. Storage device 32 may also include identification database 36 and rule set database 40. Identification database 36 may include data for a plurality of identification tags as established for one or more use environments. Rule set database 40 may include data for a plurality of rule sets, each rule set being associated with one of the plurality of identification tags. As described above, rule sets may provide a paradigm for different levels of operation privileges for a given use environment. Although shown as separate databases, identification database 36 and rule set database 40 may reside in a single database. Storage device 32 may also include other data 41, such as data pertaining to encryption information, for example. Data concerning master/slave relationships of the programmable keys may also be included. Data 41 may be used by instructions such as program instructions 34 and/or authentication program 38.

Primary encoding device 14 may be a computational device including a processor 42 and one or more storage devices 44. Similar to storage device 32, storage device 44 may take on many forms, such as volatile or non-volatile memory, a magnetic disk such as a hard drive or a floppy drive, an optical disk or a magnetic tape. Storage device 44 may include program instructions 46 that may be stored as “executable files” in storage device 44 and loaded into system memory during execution. Program instructions 46 may include various program instructions used to implement networking functions of primary encoding device 14, such as establishing communication over network 12 with application service provider 10, for example. Instructions 46 may also include instructions for authenticating components which interface to primary encoding device 14. Storage device 44 may also include encoding program 50. Although encoding program 50 may be implemented using program instructions such as instructions 46, encoding program 50 is shown separately in FIG. 2 to highlight this feature of primary encoding device 14. Encoding program 50 may include instructions for programming a plurality of programmable keys 18 and a plurality of authentication devices 20. In particular, encoding program 50 may include instructions for programming one or more identification tags to programmable key 18. Encoding program 50 may also include instructions for programming a plurality of identification tags and associated rule sets to authentication device 20. Encoding program 50 may also include instructions for re-authenticating programmable key 18 and/or permanently disabling functionality of programmable key 18.

Storage device 44 may also include identification data 48 and rule set data 52. Identification data 48 may include data for a plurality of identification tags. The data may encompass a portion of the identification tags stored on identification database 36 of application service provider 10 or the entire portion. Alternatively, identification data 48 may also be temporarily stored in storage device 44 as needed for programming of programmable key 18 and/or authentication device 20. In other words, primary encoding device 14 may retrieve the desired identification tag from application service provider 10 to program the key and/or retrieve the desired identification tag and associated rule set from application service provider 10 to program authentication device 20. Rule set data 52 may include data for a plurality of rule sets associated with the plurality of identification tags stored in identification data 48. The data may encompass a portion of the rule sets stored on rule set database 40 of application service provider 10 or the entire portion. In some embodiments, rule set data 52 may further include data for a plurality of additional rule sets that augment the core rule sets that exists on application service provider 10. The additional rule sets may be generated to better suit the use environment as needed. In similar fashion, rule set data 52 may also be temporarily stored in storage device 44 as needed for programming of authentication device 20. Other data 53 may also be included in storage device 44. Other data 53 may include data such as key use history data, for example. The data may be retrieved from programmable key 18 and be used in determining re-authentication of programmable key 18. Other types of data may be stored in data 53, such as data for master/slave relationships of the programmable keys and data pertaining to encryption information, for example. Data 53 may be used by instructions such as program instructions 46 and/or encoding program 50.

Auxiliary encoding device 16 may be a computational device including processor 54 and one or more storage devices 55. Similarly, storage device 55 may take on many forms as those described for storage device 32 and storage device 44. Storage device 55 may include program instructions 56 that may be stored as “executable files” in storage device 55 and loaded into system memory during execution. Program instructions 56 may include various program instructions used to implement networking functions of auxiliary encoding device 16, such as establishing communication over network 12 with application service provider 10, for example. Instructions 56 may also include instructions for authenticating components which interface to auxiliary encoding device 14. Storage device 55 may also include encoding program 58. Although encoding program 58 may be implemented using program instructions such as instructions 56, encoding program 58 is shown separately in FIG. 2 to highlight this feature of auxiliary encoding device 16. Encoding program 58 may include instructions for re-authenticating programmable key 18. Encoding program 58 may therefore further include instructions for programming programmable key 18 with the identification tag that has been stored on programmable key 18. Storage device 55 may also include data 59. Data 59 may include data such as key usage data, for example. Key usage data may be retrieved from programmable key 18 and be used in determining re-authentication of programmable key 18. Other types of data may be stored in data 59, such as data for identifying master/slave relationships of the programmable keys and data pertaining to encryption information, for example. Data 59 may be used by program instructions 56 and/or encoding program 58.

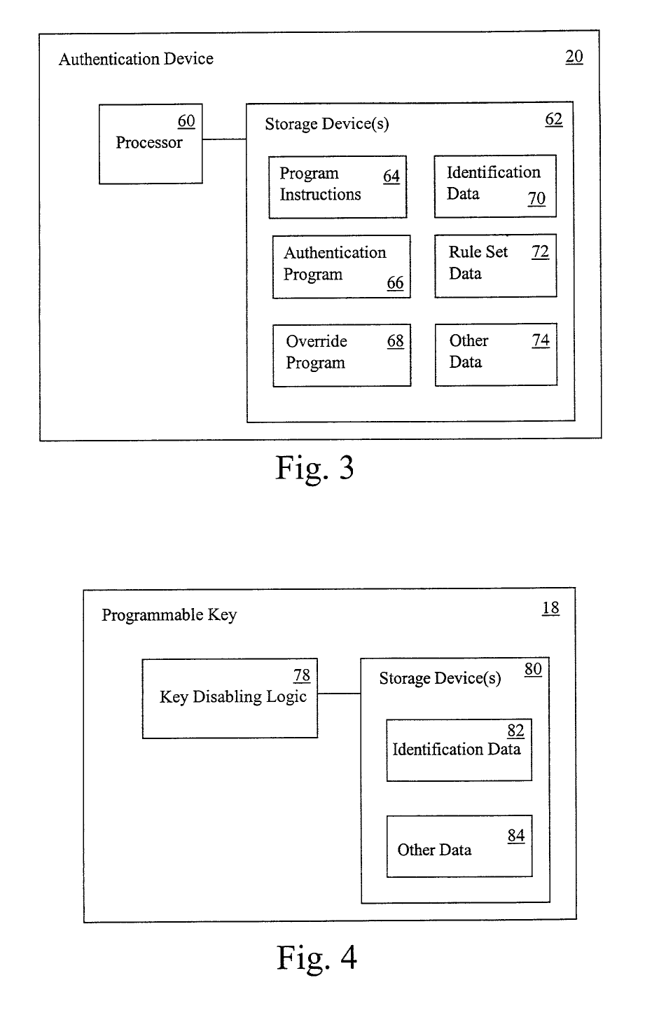

FIG. 3 illustrates a block diagram showing embodiments of elements that may be included in authentication device 20. Authentication device 20 may be a computational device including processor 60 and one or more storage devices 62. Storage device 62 may take on many forms similar to those described for storage device 32, storage device 44, and storage device 55. Storage device 62 may include program instructions 64 that may be stored as “executable files” in storage device 55 and loaded into system memory during execution. Program instructions 64 may include various program instructions used to implement networking functions of authentication device 20, such as establishing communication with primary encoding device 14 and programmable key 18 for example. Instructions 64 may also include instructions for authenticating components which interface to auxiliary encoding device authentication device 20. Storage device 62 may also include authentication program 66 and override program 68. Although both programs may be implemented using program instructions such as instructions 56, authentication program 66 and override program 68 are shown separately in FIG. 3 to highlight these features of authentication device 20. Authentication program 66 may include instructions for reading the identification tag stored on programmable key 18 and comparing it with the plurality of identification tags that may be stored on authentication device 20. If a match is present, program 66 may then allow the user of the programmable key the level of operation, aligned with that identification tag, as stored in the associated rule set. If a match is not present, program 66 may deny a user any operation privileges or may grant a user a default level, which may be a very limited level of operation privileges. Authentication program 66 may also include instructions for permanently disabling functionality of a programmable key and or re-authenticating the key. Override program 68 may include instructions for bypassing the current level of operation privileges and allow a user full operation privileges.

Storage device 62 may also include identification data 70 and rule set data 72. Identification data 70 may include data for a plurality of identification tags as programmed into authentication device 20 by primary encoding device 14. Rule set data 72 may include data for a plurality of rule sets as programmed by primary encoding device 14. The rule sets stored in rule set data 72 may be associated with the plurality of identification tags stored in identification data 70. Other data 74 may also be included in storage device 62. Data 74 may include data such as key usage data that may be transferred to programmable key 18, for example. Key usage data may include operational characteristics of the use environment as utilized by a user. Data 74 may also include data associated with establishing operational parameters based on the rule set being employed as a result of identifying programmable key 18. These parameters may interface with the use environment to allow the corresponding level of operation privileges. Data 74 may also include data pertaining to encryption information. Data 74 may be used by program instructions 64, authentication program 66, and/or override program 68.

Turning now to FIG. 4, a block diagram is presented illustrating elements that may be included in embodiments of programmable key 18. As mentioned above, programmable key 18 may physically take on the shape of a conventional key used in a conventional lock/key system. It may also mechanically interact with a lock as known in the art. However, programmable key may include additional features to allow functionality with the keyed authentication system and methods as described herein. Programmable key 18 may include storage device 80. Storage device 80 may take on many forms similar to those of storage devices 32, 44, 55, and 62. In a presently preferred embodiment, storage device 80 may be non-volatile memory such as flash memory, read-only memory (ROM), electrically erasable read-only memory (EPROM), for example. Storage device 80 may include identification data 82, which includes data for one or more identification tags as programmed by primary encoding device 14 or auxiliary encoding device 16. Although not shown, storage device may also include a plurality of associated rule set data. Storage device 80 may also include other data 84. Data 84 may include data such as key usage data, which may be written into other data 84 by authentication device 20. Data 84 may also include data for identifying master/slave relationships of programmable key 18 and data pertaining to encryption information. Programmable key 18 may also include key disabling logic 78. Key disabling logic 78 provides means for the functionality of programmable key 18 to be permanently disabled by primary encoding device 14 and/or authentication device 20. In one embodiment, disabling logic 78 may disable accessibility to storage device 80 to prevent the identification tag stored in identification data 82 from being read. Consequently, programmable key 80 would be rendered unidentifiable and not usable by the keyed authentication system. Alternatively, the key may then be treated as a “dumb” key by the system and associated with a very limited level of operation privileges. Although not shown, programmable key 18 may also include a processor coupled to key disabling logic 78 and storage device 80. Key disabling logic 78 may also be a part of the processor itself. In effect, programmable key may a “smart-card” key in some embodiments.

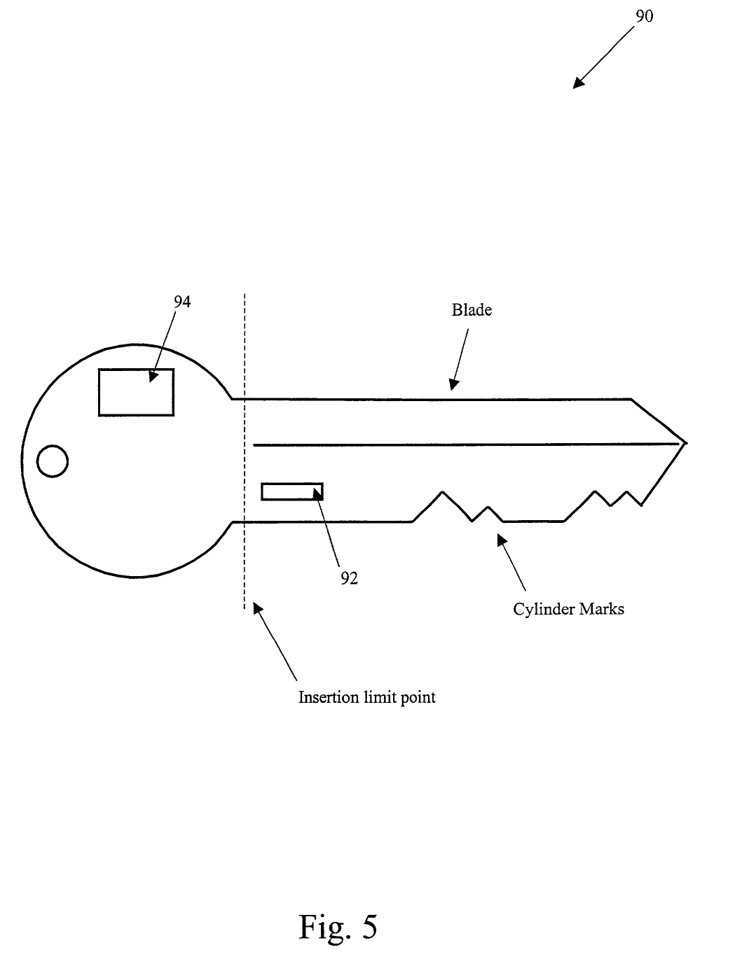

FIG. 5 illustrates an embodiment of the physical structure of a programmable key that may be employed in the systems and methods described herein. Broadly speaking, a programmable key may be any access device that may be used to gain operation privileges to a use environment. Programmable key 90 interfaces with a given lock or security system as governed by authentication device 20. In FIG. 5, programmable key 90 may physically be similar to conventional key used in lock/key systems known in the art. For instance, programmable key 90 may have typical features such as a blade and cylinder marks, which may vary according to the lock type. However, programmable key 90 may include the following additional features. Logic area 94 may include the elements of FIG. 4 as described herein, including key disabling logic 78 and storage device 80. Conduction point 92 may be a conductive medium that may be electronically connected to logic area 94. Upon being inserted into a cylinder of a lock system, programmable key 90 may be in electrical communication with contacts or wiring within the lock cylinder via conduction point 92. Accordingly, data may then be read from or written to programmable key 90 through conduction point 92 to an authentication device electrically coupled to the contacts or wiring within the lock cylinder. Conduction point 92 may also be positioned sufficiently as to be inaccessible to the outside environment when programmable key 90 is inserted. Although FIG. 5 merely illustrates one embodiment of a programmable key, it is understood that alternative key designs may be employed. The key may physically interface with a locking mechanism or alternatively interface through wireless means. All such lock/key designs would further be obvious to one skilled in the art upon knowledge of this disclosure.

In FIG. 1 and any other block diagrams appearing herein, the blocks are intended to represent functionality rather than specific structure. Implementation of the represented system using circuitry and/or software could involve combination of multiple blocks into a single circuit, device, or program, or combination of multiple circuits, devices and/or programs to realize the function of a block. Those of ordinary skill in the art will appreciate that the hardware in which the invention is implemented may vary depending on the system implementation. For example, the system may have one or more processors, and other peripheral devices may be used in addition to or in place of the hardware mentioned above. In addition to being able to be implemented on a variety of hardware platforms, the present invention may also be implemented in a variety of software and firmware embodiments. The processes of the present invention are also capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

Furthermore, a keyed authentication system such as system 5 of FIG. 1 may include other elements not explicitly shown. Such elements are not shown merely for simplification purposes and may be dependent on the use environment of the system. For example, application service provider 10, primary encoding device 14, auxiliary encoding device 16, programmable key 18, and authentication device 20 may include the appropriate hardware/software interfaces for establishing communication links with each other over a network such as network 12, or with each other directly. For example, encoding devices 14 and 16 may include a provision for insertion of programmable key 18 into the encoding devices to establish communication links. For embodiments in which communication is established through a wireless transmission medium, means for wireless transmission may be included, such as transceivers and/or receivers on the appropriate devices, for example. The devices may also include input/output means for entering or displaying information, such as keyboards, keypads, pointing devices, printers, monitors, and liquid crystal displays, for example. The present invention is intended to embrace these embodiments as well as other embodiments falling within the scope of the invention. Furthermore, the term “computational device” as used herein is understood to embrace all types of devices that perform some level of logic processing. Some examples of computational devices include a client computer, computer workstation, computer server, laptop computer, network appliance, portable digital assistant, wireless device, and vehicle telematics.

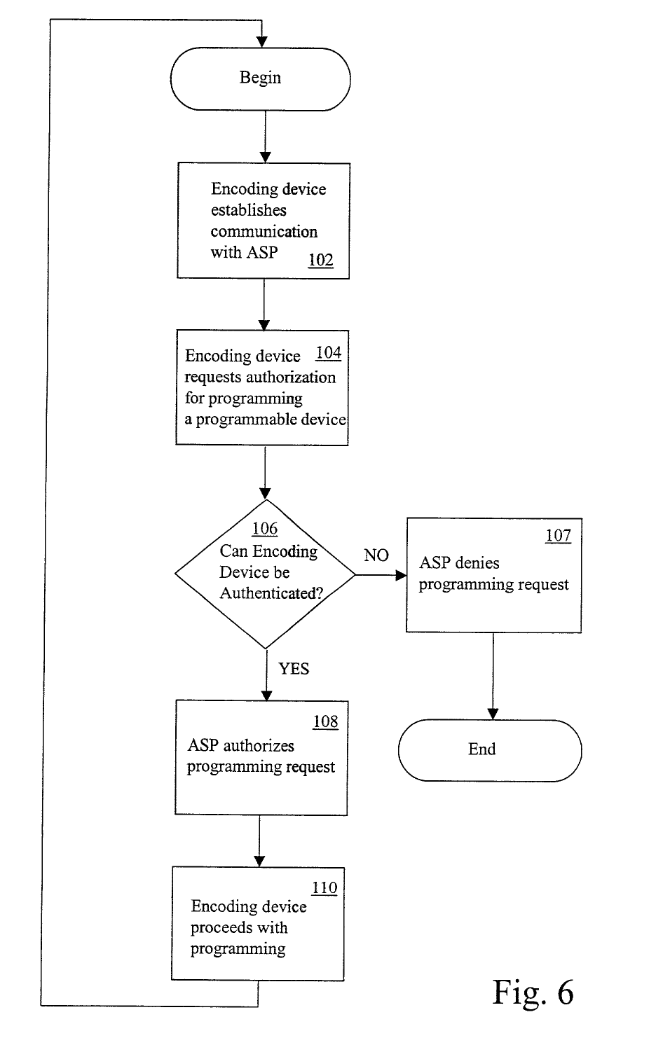

Turning now to FIG. 6, a flow diagram for an embodiment of a programming sequence is shown. The programming sequence may be employed by a keyed authentication system such as system 5 of FIG. 1. The programming sequence may be performed whenever an encoding device, such as primary encoding device 14 or encoding device 16, wishes to program a programmable key or an authentication device. For simplification purposes, the method assumes that a communication link between the encoding device and the programmable key has been established. The method may then begin, as shown in block 102, with the encoding device establishing a communication link with an application service provider, such as application service provider 10 of FIG. 1. Upon linking to the application service provider, the encoding device may request authorization for programming a programmable device such as programmable key 18 or authentication device 20 of FIG. 1 as shown in block 104. The ASP may then determine if the encoding device is a trusted source, i.e. an authenticated source as established by the ASP (decision box 106). If the encoding device cannot be authenticated by the ASP, as illustrated by the “NO” branch of decision box 106, the ASP may deny the programming request submitted by the encoding device (box 107). If the encoding device can be authenticated by the ASP (“YES” branch of decision box 106), the ASP may authorize the programming request and indicate to the encoding device as such (box 108). The encoding device may then proceed to program, as described herein, the desired device accordingly, as shown in box 110. Upon completion of programming, the sequence may then revert to receiving another program request from the encoding device as shown. In a presently preferred embodiment, each program request may require authentication with the ASP. Such requirements may minimize the frequency of unauthorized programming from non-trusted sources.

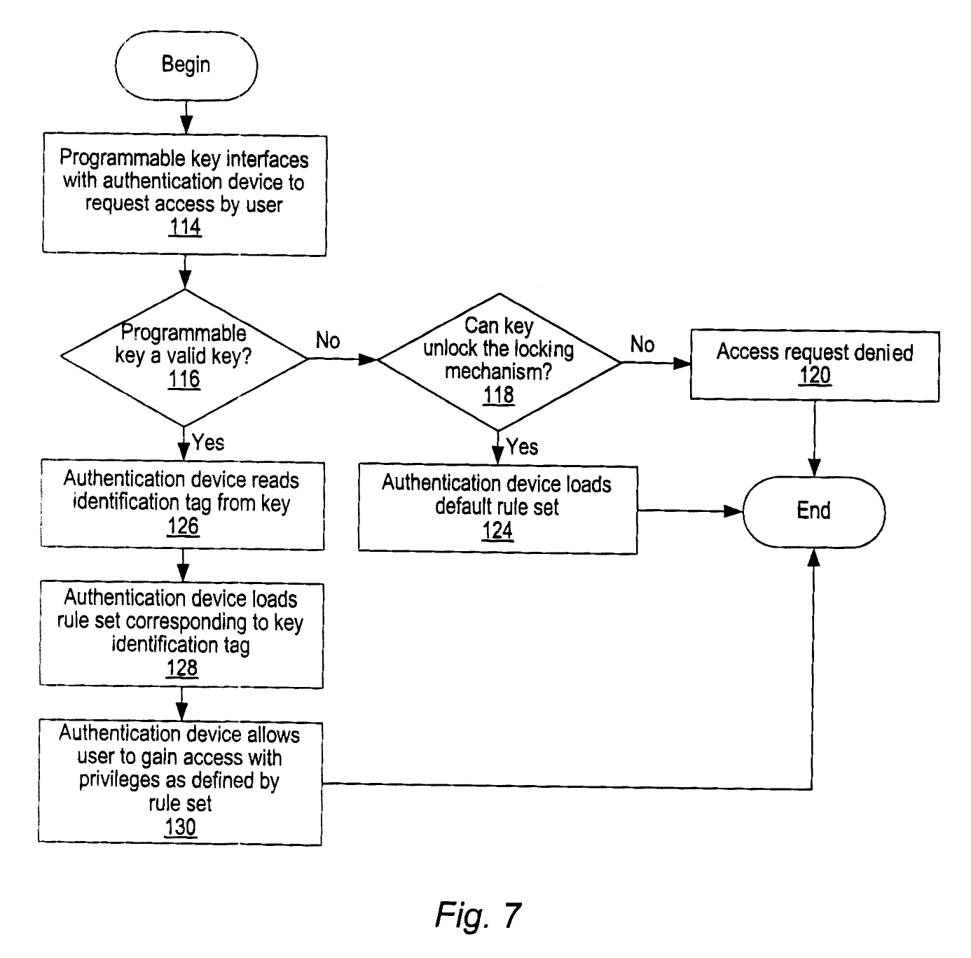

FIG. 7 illustrates a flow diagram for an embodiment of a validation sequence between a programmable key and an authentication device as employed by a keyed authentication system such as system 5. The validation sequence may occur when a user, in possession of the programmable key, desires operation privileges to the use environment. The sequence may begin by a programmable key, such as programmable key 18, interfacing with an authentication device, such as authentication device 20, as shown in box 114. The term “interfacing” may be understood to encompass having the key in a communication link with the authentication device. The communication link may be established in many ways. For example, a user may physically insert the key into a locking mechanism which is coupled to the authentication device. Alternatively, the key may link to the authentication device through wireless transmission media as described herein, and require no physical insertion. The authentication device may then determine if the key is a valid key (decision box 116). A programmable key being a valid key may take on one or more meanings. First, the programmable key may be required to be authenticated by the authentication device. Second, the programmable key may be determined if the key is intended for use with the authentication device. In other words, authentication device ensures that the key does not “belong” to another keyed authentication system. Third, authentication device may further determine if the programmable key's identification tag has not “expired”, i.e. needing re-authentication. Fourth, the authentication device may compare the identification tag stored on the programmable key to the plurality of identification tags stored on the authentication device. If a match exists, the key may be valid. If a match does not exist, the key may be invalid.

If the programmable key is determined by the authentication device to be a valid key, the authentication device proceeds to read the identification tag stored on the key, as shown by the “YES” branch of decision box 116 and box 126. The corresponding rule set to the identification tag may then be retrieved by authentication device as shown in box 128. The rule set may establish the level of operation privileges, the user may gain for the use environment as shown in box 130. Naturally, it is understood that the authentication device may interface to another device of the use environment in order to set the level of operation privileges. If the programmable key is not a valid key as shown by the “NO” branch of decision box 116, the key may still be able to unlock the locking mechanism employed in the use environment. For example, the key functionality may have been previously disabled as described herein, yet the key would still able to operate the physical locking mechanism. If the programmable key can unlock the locking mechanism, authentication device may retrieve a default rule set, which may limit the level of operation privileges as defined by that rule set (“YES” branch of decision box 118 and box 124). If the key is unable to unlock the locking mechanism, operation may naturally be denied as indicated in the “NO” branch of decision box 118 and box 120. Variations of the validation sequence may be performed. For example, in use environments with extreme security requirements, such as intelligence, for example, if a programmable key cannot be validated, the authentication device may deny operation privileges regardless of whether the key may still physically unlock the locking mechanism.

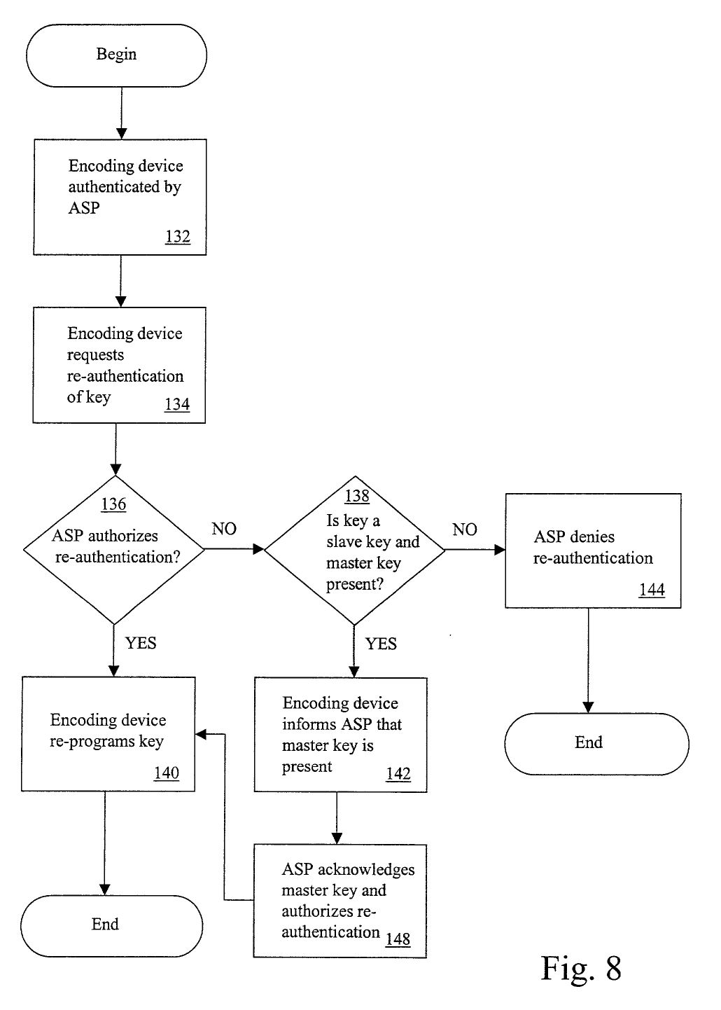

FIG. 8 illustrates a flow diagram for an embodiment of a key re-authentication sequence that may be employed by a keyed authentication system such as system 5 of FIG. 1. As described herein, programmable keys may periodically be required to be re-authenticated to avoid unauthorized use of the keys. Re-authentication may be achieved by an encoding device. For simplification purposes, the method assumes a communication link has been established between the encoding device and the programmable key. The sequence may be initiated by an encoding device, such as primary encoding device 14 or auxiliary encoding device 16, being authenticated by the application service provider as shown in box 132. The encoding device may request from the application service provider permission for re-authenticating the programmable key as shown in box 134. The application service provider may then proceed to determine if re-authentication should be authorized (decision box 136). Determining if a key may be re-authenticated may be a function of the rule set established. For example, a rule set may establish that the key may have a finite use period or not be able to be re-authenticated without the “master” key at all times. Alternatively, a rule set may include comparing data stored on the key with established threshold limits on the application service provider. The data may include data such as key use history, for example. If any of the data exceeds the specified threshold limit, the rule set may permanently disallow re-authentication or may require the master key to be present. The key may also require a periodic re-authentication regardless. If the application service provider determines the key should be re-authenticated, the encoding device is so informed and the key is re-programmed (“YES” branch of decision box 136 and box 140).

However, if the application service provider does not authorize re-authentication of the key, in some embodiments the key may still be re-authenticated if the key is a slave key to a master key. Accordingly, if the master key is present, i.e., in a communication link with the encoding device, the encoding device may inform the ASP the master key is present and authenticated by the encoding device to be the “parent” key as shown by the “YES” branch of decision box 138 and box 142. The ASP may then acknowledge the authentication and presence of the master key and authorize the re-authentication request (box 138). The encoding device may then proceed to re-program the key as shown by box 140. If the master key is not present or cannot be authenticated by the encoding device, the ASP continues to deny the re-authentication request as shown by the “NO” branch of decision box 138 and box 144.

The exemplary flow diagrams described herein are meant to illustrate the concepts of how a keyed authentication system in accordance with the present invention may be utilized. Naturally, there may be countless variations or additions to these and other flow diagrams, not shown, of the system. The variations or modifications may be entirely dependent on the use environment as well as the needs of the users. The alternative methods would be well in purview of one skilled in the art upon knowledge of this disclosure.

Exemplary Use Environments

The embodiments of the keyed authentication systems and methods described herein are applicable to a wide range of use environments. Because of the flexibility inherent in the system, a plurality of operation privileges may be readily tailored to a given use environment. Use environments may include environments such as vehicles, buildings, homes, computers, equipment, and intelligence. One use environment that is ideally suitable for such a system is vehicle security and operation. “Vehicle” as used herein may embrace all modes of transportation, including automobiles, aircraft, and watercraft. Described herein below are various implementations of the system for automobiles, which can be readily extendable to other types of vehicles.

In a vehicular environment, a keyed authentication system as described herein may include an application service provider that governs the authorization of identification tags and rule sets which may be programmed by one or more primary encoding devices and auxiliary encoding devices. Primary encoding device would be a trusted source for programming of the programmable keys and authentication devices. Similarly, auxiliary encoding device would also be a trusted source for programming of keys. Nevertheless, both primary encoding device and auxiliary encoding device may still require authentication to the application service provider periodically or for each programming request. The application service provider may service specific vehicle business entities, such as retail dealerships, rental dealerships, and company fleets. Consequently, the primary encoding devices may reside with these entities which together, along with the application service provider, form a secure and trusted relationship by which programmable keys and authentication devices are administered.

Programmable keys are distributed to users of the vehicle and may be used to operate the vehicle. A vehicle may include an authentication device that is coupled to the vehicle's engine performance system. The device may also be coupled to the vehicles electronics system. Alternatively, the authentication device may be integrated within the engine performance system and/or the electronics system. Upon insertion of the programmable key into the door lock or the ignition lock of the vehicle, the authentication device may read the identification tag stored on the programmable key and retrieve the associated rule set. The associated rule set may specify operation parameters for the engine performance system and/or electronics system. The authentication device may then transmit these parameters to the respective engine control module and electronics control module. The vehicle may perform along these parameters until the vehicle is stopped and the programmable key is removed from the ignition lock. The authentication device may also monitor the vehicle's operational performance and record the operational data onto the programmable key. The device may also be able to activate the key disabling logic on the programmable key. For example, an override feature may also be present to allow a user to bypass the current level of operation privileges. Upon activation of the override feature, the authentication device may proceed to activate the key disabling logic of the programmable key and further instruct the engine control module and/or the electronics control module to perform according to full capabilities. Such a feature may be useful in an emergency situation and allow for a one-time use, since the programmable key would be rendered non-functional (the identification tag would be non-accessible by the authentication device) during future attempts to operate the vehicle. For vehicles which incorporate telematic features, such as General Motor Corporations' OnStar™, Ford Motor Company's Delphi™, or a Global Positioning System (GPS), for example, the authentication device may interface with the telematics to notify the governing authorities in appropriate situations as defined by the rule set. Interfacing with the vehicle's telematics would also allow the authentication device to have a wireless communications link to the application service provider or any of the encoding devices as well.

Auxiliary encoding devices may be distributed to owners of the vehicle. As described herein, the auxiliary encoding device allows a programmable key to be re-authenticated with the system for allowing continued use of the key as programmed. The auxiliary encoding devices may take on many forms. For instance, the auxiliary encoding device may be a computational device such as, a network appliance, for example, that may be connectable via a phone line, a cable line, or a wireless medium for linking to application service provider to request re-authentication The auxiliary encoding device may be intended for use at a vehicle owner's residence, for example. Alternatively, the device may also be installed within the vehicle. Furthermore, both the primary and auxiliary encoding devices may also be matched to respective programmable keys and authentication devices, such that an encoding device for one make of a vehicle may not be able to program the keys and authentication devices for another make of a vehicle. This may be achieved through the encryption schemes described herein.

A plurality of rule sets may be established by application service provider 10 and/or the vehicle business entities. These rule sets may be aligned to a plurality of identification tags that may be programmed into a programmable key. Defining the rule sets and which sets to program into the authentication devices of the vehicles are entirely left up to the application service provider and the vehicle business entities. However, to illustrate the concept of a rule-based operation and keyed authentication system as described herein, exemplary rule sets shall now be given. In an embodiment, a first rule set (“normal mode”) may allow a vehicle to be operated without restriction. A programmable key with the identification tag for normal mode, or any other mode, may require re-authentication periodically. The duration between re-authentication may be set according to the application service provider. If a key is not re-authenticated, the key may be prevented from operating the vehicle in normal mode during future attempts. A display indicator on the key may indicate the number of days remaining before re-authentication may be required. The key may also be re-authenticated in advance of the “expiration” date. The overlapping period may be entirely definable and associated with a given rule set.

A second rule set, (“default mode”) may allow a vehicle to operate normally, except that speeds cannot exceed a specified value. Default mode may also include having the vehicle's headlights and/or running lights on continuously. Electrical devices such as radios, for example, may not be operable and if the vehicle is run for more than a set time period, the vehicle's telematics system may be notified. In some embodiments, the vehicle may cease to operate after a specified time period. Operational limitations are entirely programmable and not restricted to such examples. A programmable key may be stored with this identification tag and be ideal in valet situations and security situations. Alternatively, default mode may be the also be the base operating mode of a vehicle, i.e., the vehicle may always operate in this mode unless the authentication device loads in a different rule set.

A third rule set, “restricted mode” may allow a vehicle to operate normally during specified times in a day or during specified days. Outside these time periods, the vehicle may revert to default mode. Additionally, the authentication device may accumulate driver-operating metrics, i.e., “key usage data,” such as vehicle speed, acceleration, braking, for example, which may be transferred into the programmable key. Upon the next key re-authentication period, the data may be retrieved from the key by the auxiliary encoding device and be used for determining whether the key should be re-authenticated. If the data shows certain rules such as the vehicle speed limit, vehicle acceleration limit, and/or vehicle braking time are violated, for example, the application service provider may deny re-authentication of the programmable key. Thus, in order for that key, with the restricted mode identification tag, to be re-authenticated, it may need to be authorized by its master key, which may have the normal mode identification tag. In this sense, the “restricted mode” key may be a slave to the “normal mode” master key. Consequently, when re-authentication is desired through the primary or the auxiliary encoding device, both the master and the slave key may require establishing a communication link to the application service provider. The application service provider may then acknowledge the master/slave key relationship and re-authentication may proceed accordingly. This may be useful for monitoring driving habits of drivers with use restrictions such as younger family members or a driver, with a driving under the influence conviction, who is being monitored by a law enforcement agency, for example.

A fourth rule set, “panic mode” may allow the vehicle to operate normally regardless of the current rule set operating the vehicle. Such a mode may be useful in emergency situations when the driver may require full operational capabilities. In an embodiment, there may be a provision for an override feature located in the vehicle. Once initiated, the authentication device may acknowledge the request and proceed to load in the “normal mode” rule set. The device may also trigger the key disabling logic on the programmable key. The override feature may be a button, when pressed remains in that position, to signal the request for the panic-mode. The button may be reset by bringing the vehicle to a trusted encoding entity, such as the car dealership for example. Alternatively, a keypad may be provided for entrance of a personal identification number, know only by the user, to enable the override feature. Activation of the panic mode may also trigger notification to the governing authorities of the vehicle's telematics, if present, or to other security providers such as LoJack™, for example.

For retail car dealerships, the “restricted mode” concept may further be limited to the number of minutes and/or a number of miles that the vehicle may be driven during a test-drive. That is, the vehicle may operate normally until the desired time limit or distance has been reached. At this point, the vehicle may then revert to the “default mode.” Thus, keys may be programmed accordingly and given to a prospective buyer for the test-drive. The rule set may also require the key to be re-authenticated after each use. Such a rule set may reduce the potential for “drive-offs” or other undesirable uses of the vehicles.

For rental dealerships, the “restricted mode” concept may be extended to the number of days a vehicle may be rented. During this period, the vehicle may operate normally. After this period, the vehicle may revert to “default mode.” If the user of the renter vehicle wishes to extend the rental length, the programmable key may be required to be re-authenticated at the rental dealership. Driver-operating metrics may also be recorded into the authentication device and transferred into the programmable key. The data may be reviewed by the rental dealership and identify drivers who meet their safe-driving criteria. Such drivers may be offered lower rental prices or other benefits in reward for reducing the potential for accelerated depreciation of the rental cars.

For company fleets, the “restricted mode” concept may also be employed. Company vehicles may be limited to certain hours of operation and may further be entirely non-operable after certain hours of the day. Programmable keys may require periodic re-authentication at which time driver-operating metrics data may be reviewed for possible disciplinary actions for drivers who perform infractions against the vehicle use criteria as established by the company. Furthermore, the company fleet may install identical locking mechanisms in all of the vehicles and govern their operation by the programmable keys. This may eliminate the need for complicated inventories of different key/lock combinations to be maintained.

As evidenced by the above-described examples of the rule sets and identification tags that may be employed, the rule-based operation and keyed authentication system as described herein provides for total flexibility to any vehicular environment. The set of rules and the identification tags are entirely up to the needs of the business entity employing the keyed authentication system. The total programmability of the system may allow for reuse in a vehicle's life cycle. In particular, vehicle manufacturers may install the authentication device as part of the engine control module and/or the electronics control module at the production factory. The authentication device may be initially programmed to “default mode.” Upon being shipped to retail car dealerships, rental dealerships, or company fleets, a plurality of “pre-ownership” rule sets and identification tags may be programmed into the authentication device as needed. When the vehicle is purchased by a consumer, additional rule sets and identification tags may be programmed as suited to the consumer. If the vehicle is sold to another private owner or resold to a dealer, the authentication device may simply be reprogrammed with another set of rules and identification tags. This may be done at authorized service centers, which are trusted sources with the application service provider, or it may also be performed at the original retail dealership.

Moreover, the concept of a central authority administering the plurality of identification tags and associated rule sets may further be conducive to introducing fiduciary components in the keyed authentication systems as described herein. For example, the application service provider may service a number of retail car dealerships and retail rental dealerships. The applications service provider may not have any affiliation with the dealerships aside from administering the identification tags and the associated rule sets and authenticating programming requests. For each event between the application service provider and the components within the keyed authentication system (e.g., encoding device, programmable keys, and authentication devices), a transactional fee may be charged and billed to the dealerships. Furthermore, the use of encryption techniques such as PKI may ensure the charges are authorized and accurate, i.e., only trusted sources may obtain authorization from the application service provider to program. The dealerships may utilize this business model to offer the keyed authentication system as a distinguishing feature over their competitors and perhaps embed the additional overhead into their retail pricing of the vehicles. Naturally, this concept of a fiduciary component to the keyed authentication systems as described herein may be extendable to any of the use environments.

Described above are exemplary embodiments of a rule-based operation and service provider authentication keyed system tailored to vehicles. The system may also be readily extended to a plurality of other use environments. For example, in the area of home security, a keyed authentication system as described herein may provide an extra level of protection for home security systems. An authentication device may be coupled to the home's front door locking mechanism and the control module for any electrical alarm system within the residence. Keys may be programmed with a plurality of identification tags and the authentication device may be programmed with the plurality of identification tags and the associated rule sets. Exemplary rule sets may include a rule set authorizing disabling of the alarm system protecting a safe only if the front door is unlocked with the “parental” keys. A rule set may also allow all programmable keys to open a locked firearms cabinet, but only the parental keys may be able to disarm the alarm system. Operational limitations are entirely programmable and not limited to these examples. An authentication device may also be coupled to operational equipment within the home. For example, unlocking the front door with the any key other than the parental keys may limit the operation of the stove and range to lower heating temperatures. Naturally, this concept can be applied to all other operational equipment in the other use environments as well.

In environments such as commercial buildings, e.g., hotel rooms, a keyed authentication system as described herein may also be readily adapted. A plurality of authentication devices may each be coupled to a locking mechanism of each hotel room and govern the level of operation for a user. For example, a rule set may establish a programmable key to “expire” after checkout. The hotel may also be able to monitor any unauthorized use of the programmable key. In particular, a rule set may establish the housekeeper's keys to be usable only during their work shift. If the key is attempted for entrance during any other time, the authentication device may enable the key disabling logic of the key and a notification may be sent to the hotel security. Billable services located inside the room, such as beverages and snacks located inside the refrigerator and the personal safe, for example, may further be prevented from being accessed.

In the area of intelligence, the keyed authentication system may also be employed. Authentication devices may be coupled to locking mechanisms for high-security areas or rooms. A rule set may be established such that the programmable key may be a one-time use key only, i.e., “one-time validation” ability. Users may not need to be given any secret operational codes or other similar operational information. As long as they have the appropriate programmed key and insert it into the correct lock, entrance may be granted. Alternatively, in conjunction with traditional biometric or keypad authentication methods, the keyed authentication system may provide another level of security. For example, the system may include a rule set such that if an unauthorized programmed key is used to gain access, the authentication device may trigger the key disabling logic and disable the biometric or keypad authentication means. In other words, once the programmable key invalidates the security system, no code orbiometric feature would suffice to grant access. Similarly, computer equipment and files may be restricted to a system including biometric authentication and the keyed authentication system described herein.

It will be appreciated by those skilled in the art having the benefit of this disclosure that this invention is believed to provide a system and method for rule-based keyed operation and service provider authentication. Furthermore, it is also to be understood that the form of the invention shown and described is to be taken as exemplary, presently preferred embodiments. Various modifications and changes may be made without departing from the spirit and scope of the invention as set forth in the claims. For example, the system and methods described herein may be implemented using many combinations of hardware and/or software, and at one or more of many different levels of hardware and/or software, as is the case with many computer-related applications. It is intended that the following claims be interpreted to embrace all such modifications and changes.

What is claimed is:

1. A network system for providing a level of operation privileges to a user, the system comprising:
a first computational device comprising a plurality of identification tags and associated rule sets, wherein each identification tag and rule set pair establishes a level of operation privileges to the user; and
a second computational device adapted to program an access device with at least one of the identification tags upon authorization from the first computational device.

2. The network system of claim 1, wherein the second computational device is further adapted to program an authentication device with a plurality of the identification tags and associated rule sets upon authorization from the first computational device.

3. The network system of claim 2, wherein the authentication device is adapted to interface with the access device and provide the corresponding level of operation privileges to the user if the identification tag programmed on the access device matches with at least one of the identification tags programmed on the authentication device.

4. The network system of claim 1, further comprising a third computational device adapted to program the access device with at least one of the identification tags upon authorization from the first computational device.

5. The network system of claim 4, wherein the access device is adapted to be periodically re-authenticated by the third computational device upon authorization from the first computational device.

6. The network system of claim 1, wherein the first, second, and third computational devices are interconnected via a network such as the Internet.

7. A network system for providing a level of operation privileges to a user, the system comprising an encoding device adapted to program an access device with at least one identification tag upon authorization by a central authority connected to the network system.

8. The network system of claim 7, wherein the encoding device is further adapted to program an authentication device with a plurality of identification tags and associated rule sets upon authorization by the central authority.

9. The network system of claim 8, wherein the central authority is adapted to maintain and administer the plurality of identification tags and associated rule sets.

10. The network system of claim 8, wherein each identification tag and rule set pair establishes a level of operation privileges for the user.

11. The network system of claim 10, wherein the authentication device is adapted to provide the corresponding level of operation privileges, if upon establishing a communication link with the access device, the authentication device matches the identification tag stored on the access device with at least one the plurality of identification tags stored on the authentication device.

12. The network system of claim 7, wherein the network system comprises the Internet.

13. A communication network for providing a level of operation privileges to a user, the system comprising a central authority arranged in the network and comprising a plurality of identification tags and associated rule sets, wherein each identification tag and rule set pair establishes a level of operation privileges for the user.

14. The network of claim 13, further comprising an access device adapted to store at least one of the plurality of identification tags and an authentication device adapted to store a plurality of the identification tags and associated rule sets.

15. The network of claim 14, further comprising an encoding device adapted to program the access device with at least one of the plurality of identification tags upon authorization from the central authority.

16. The network of claim 14, wherein the encoding device is further adapted to program the authentication device with a plurality of the identification tags and associated rule sets upon authorization from the central authority.

17. The network of claim 14, wherein the authentication device is adapted to interface with the access device and provide the corresponding level of operation privileges to the user if the identification tag stored on the access device matches with at least one of the plurality of identification tags stored on the authentication device.

18. The network of claim 13, wherein the network comprises the Internet.

19. A network system for providing a level of operation privileges to a user, the system comprising:
an access device adapted to store a programmed identification tag, wherein the identification tag is programmed upon authorization by a central authority connected to the network system; and
an authentication device adapted to store a plurality of programmed identification tags and associated rule sets, wherein the plurality of identification tags and associated rule sets are programmed upon authorization by the central authority.

20. The network system of claim 19, further comprising an encoding device adapted to program the access device and the authentication device upon authorization by the central authority.

21. The network system of claim 19, wherein the network system comprises the Internet.

22. The network system of claim 19, wherein the central authority maintains and administers the plurality of identification tags and associated rule sets, and wherein each of the identification tag and rule set pair establishes a level of operation privileges for the user.

23. The network system of claim 19, wherein the authentication device is further adapted to interface with the access device and provide the corresponding level of operation privileges to the user if the identification tag stored on the access device matches at least one of the plurality of identification tags stored on the authentication device.

24. The network system of claim 20, wherein the access device is further adapted to be periodically authenticated by the encoding device upon authorization from the central authority.

25. A network system for providing a level of operation privileges to the user of a vehicle, the system comprising:
an access device adapted to store a programmed identification tag, wherein the access device is programmed upon authorization from a central authority connected to the network system; and
a vehicle comprising an authentication device adapted to store a plurality of programmed identification tags and associated rule sets, wherein the authentication device is programmed upon authorization from the central authority.

26. The network system of claim 25, wherein the central authority maintains and administers the plurality of identification tags and associated rule sets, and wherein each identification tag and rule set pair establishes a level of operation privileges to the user of the vehicle.

27. The network system of claim 25, wherein the network system comprises the Internet.

28. The network system of claim 25, further comprising an encoding device adapted to program the access device and the authentication device upon authorization from the central authority.

29. The network system of claim 26, wherein the authentication device is further adapted to interface with the access device and provide the corresponding level of operation privileges to the user if the identification tag programmed on the access device matches at least one of the plurality of identification tags programmed on the authentication device.

30. The network system of claim 26, wherein the authentication device is coupled to an engine control module to establish the operational parameters for the vehicle corresponding to the level of operation privileges provided by the authentication device.

31. The network system of claim 26, wherein the authentication device is further coupled to an electronics system to establish the operational parameters for the vehicle corresponding to the level of operation privileges provided by the authentication device.

32. The network system of claim 26, wherein the authentication device is further coupled to a telematics system to establish the operational parameters for the vehicle corresponding to the level of operation privileges provided by the authentication device.

33. The network system of claim 28, wherein the access device is further adapted to be periodically re-authenticated by the encoding device upon authorization by the central authority.

34. The network system of claim 33, wherein the access device is further adapted to store data associated with operational metrics of the user during the use of the vehicle.

35. The network system of claim 34, wherein the encoding device is further adapted to re-authenticate the access device by retrieving the data and submitting the data to the central authority.

36. The network system of claim 35, wherein the central authority is adapted to authorize the re-authentication of the access device if the data does not violate a level of eligibility for re-authentication as established by the associated rule set corresponding to the level of operation privileges provided to the user.

37. The network system of claim 26, further comprising means for bypassing the current level of operation privileges as provided by the authentication device and providing a dissimilar level of operation privileges.

38. The network system of claim 37, wherein the means for bypassing the current level of operation privileges is adapted to disable future access to the identification tag on the access device by the encoding device and the authentication device.

39. The network system of claim 25, wherein the network system comprises the Internet.

40. A method for providing a plurality of operation privileges to a user, the method comprising:
establishing a plurality of identification tags and associated rule sets, wherein each identification tag and rule set pair corresponds to a level of operation privileges that may be provided to the user; and
programming an access device with an encoding device operably linked via a network to a central authority which administers the plurality of identification tags associated rule sets, wherein said programming occurs upon authorization from the central authority, and wherein the access device is programmed with at least one of the plurality of identification tags.

41. The method of claim 40, further comprising programming an authentication device with the encoding device, wherein the programming occurs upon authorization from the central authority, and wherein the authentication device is programmed with a plurality of the identification tags and associated rule sets.

42. The method of claim 41, further comprising:
establishing a communication link between the access device and the authentication device;
retrieving the identification tag stored on the access device and comparing it with the plurality of identification tags stored on the authentication device;
retrieving the rule set associated with the identification tag stored on the access device if said comparing results in a match of the identification tag with at least one of the plurality of identification tags; and
providing the corresponding level of operation privileges to the user.

43. The method of claim 42, further comprising providing a default level of operation privileges to the user if said comparing does not result in a match of the identification tag with at least one of the plurality of identification tags.

44. The method of claim 43, further comprising bypassing the corresponding level of operation privileges and providing an alternate level of operation privileges to the user dissimilar to the corresponding level of operation privileges.

45. The method of claim 44, wherein said providing an alternate level of operation privileges comprises providing complete operation privileges to the user.

46. The method of claim 44, wherein said bypassing the corresponding level of operation privileges comprises:
receiving a request from the user for bypassing the corresponding level of operation privileges; and
disabling future access to the identification tag programmed on the access device.

47. A method for authenticating an access device used for obtaining a level of operation privileges, the method comprising:
establishing a communications link between an encoding device and a central authority connected via a network, wherein the central authority maintains and administers a plurality of identification tags and associated rule sets, and wherein each identification tag and rule set pair establishes a level of operation privileges for a user;
receiving a request from the encoding device for authenticating an access device, wherein the access device is associated with a level of operation privileges provided to the user; and
determining authorization of the authentication request.

48. The method of claim 47, wherein said determining authorization of the authentication request comprises:
authenticating the encoding device to the central authority;
retrieving data from the access device, wherein the data comprises operational metrics of the user for the corresponding level of operation privileges provided to the user by the access device; and
authorizing the authentication request if the data conforms to the level of eligibility for authentication as established by the associated rule set corresponding to the level of privileges provided to the user.

49. The method of claim 48, wherein said determining authorization of the authentication request further comprises denying the authorization request if the data violates a level of eligibility for authentication as established by the associated rule set corresponding to the level of operation privileges provided to the user.

50. A method for authenticating an access device used in obtaining a level of operation privileges, the method comprising:
establishing a communications link between an encoding device and a central authority connected via a network, wherein the central authority maintains and administers a plurality of identification tags and associated rule sets, and wherein each identification tag and rule set pair establishes a level of operation privileges for a user;
receiving a request from the encoding device for authenticating a slave access device, wherein the slave access device is associated with a level of operation privileges provided to the user; and
determining authorization of the authentication request.

51. The method of claim 50, wherein said determining authorization of the authentication request comprises:
authenticating the encoding device to the central authority;
authenticating an access device, configured as a master to the slave access device, to the central authority;
retrieving data from the slave access device, wherein the data comprises operational metrics of the user for the corresponding level of operation privileges provided to the user by the access device; and
authorizing the authentication request regardless of whether the data conforms to the level of eligibility for authentication as established by the associated rule set corresponding to the level of privileges provided to the user.

52. A computer-readable medium comprising:
first program instructions executable on a first computational device for authenticating an encoding device by a central authority coupled to the encoding device by a network; and
second program instructions executable on the first computational device for authorizing a request sent via the network from the encoding device for programming an access device with an identification tag, said access device useable for accessing a controlled environment.

53. The computer-readable medium of claim 52, further comprising third program instructions executable on the first computational device for authorizing a request from the encoding device for programming an authentication device with a plurality of identification tags and associated rule sets, wherein each identification tag and rule set pair establishes a level of operation privileges for a user.

54. The computer-readable medium of claim 53, further comprising fourth program instructions executable on a second computational device for providing the corresponding level of operation privileges to the user if the identification tag programmed in the access device matches with at least one of the plurality of identification tags programmed in the authentication device.

55. The computer-readable medium of claim 54, wherein the fourth program instructions are further executable for providing a default level of operation privileges to the user if the identification tag programmed in the access device does not match with at least one of the plurality of identification tags programmed in the authentication device.

56. The computer-readable medium of claim 55, further comprising fifth program instructions executable on the second computational device for bypassing the corresponding level of operation privileges and providing a dissimilar level of operation privileges.

57. The computer-usable carrier medium of claim 56, wherein the fifth program instructions are further executable for disabling future access to the identification tag programmed in the access device.

58. A computer-readable medium comprising:
first program instructions executable on a first computational device for authenticating an encoding device by a central authority coupled to the encoding device by a network; and
second program instructions executable on the first computational device for authorizing a request sent via the network authenticating a first access device, wherein the first access device comprises a programmed identification tag associated with a level of operational privileges for a user.

59. The computer-readable medium of claim 58, wherein the second program instructions are further executable to retrieve data from the access device, wherein the data comprises operational metrics of the user for the corresponding level of operation privileges provided to the user by the first access device.

60. The computer-readable medium of claim 59, wherein the second program instructions are further executable for authorizing the authentication request if the data conforms to the level of eligibility for authentication as established for the corresponding level of operation privileges.

61. The computer-readable medium of claim 60, further comprising third program instructions executable on the computational device for authenticating a second access device to the central authority.

62. The computer-readable medium of claim 61, wherein the third program instructions are further executable for authorizing the authentication request if the second access device is configured as a master to the first access device.
